(19) United States
(12) Patent Application Publication
(10) Pub. No.: US 2008/0015299 A1
(43) Pub. Date: Jan. 17, 2008

(54) Acicular boehmite and process for producing the same

(75) Inventors: Kazuki Takemura, Niihama-shi (JP); Yusuke Kawamura, Niihama-shi (JP); Katsuhisa Kitano, Ichihara-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited

(21) Appl. No.: 11/826,333

(22) Filed: Jul. 13, 2007

(30) Foreign Application Priority Data
Jul. 14, 2006 (JP) P2006-193846

(51) Int. Cl. C01F 7/02; C08K 3/10

(52) U.S. Cl. 524/437; 423/625

(57) ABSTRACT

Acicular boehmite having a BET specific surface area of at 20 to 80 m²/g, a dioctyl phthalate oil absorption of 200 to 600 cm³/100 g, a minor axis length of 30 to 300 nm and an aspect ratio of 5 to 50, which may be produced by hydrothermally reacting aluminum hydroxide powder at a temperature of 160 to 250° C. in an aqueous solution having pH of 4 to 6 and containing 0.1 to 5 mol/L of a salt of a metal ion selected from magnesium ion, manganese ion and zinc ion and an anion selected from carboxylate ion, nitrate ion and sulfate ion.

### FILED OF THE INVENTION

The present invention relates to acicular boehmite and a process for producing the same. In particular, the present invention relates to acicular boehmite having a particular BET specific surface area, a particular DOP oil adsorption, a particular minor axis length and a particular aspect ratio.

### BACKGROUND ART

Acicular boehmite is aluminum hydroxide having a needle-like shape and the boehmite crystalline form, and it is used, for example, as a filler for improving stiffness of resins. For example, WO 03/089508 (corresponding to JP 2005-528474 T) discloses acicular boehmite having a BET specific surface area of at least 75 m²/g, a minor axis length of 20 nm or less and an aspect ratio of at least 3.

However, the conventional acicular boehmite may not always improve the stiffness of resins sufficiently.

### SUMMARY OF THE INVENTION

An object of the present invention is to provide acicular boehmite which can further improve the stiffness of resins when the boehmite is used as a filler of the resins.

Accordingly, the present invention provides acicular boehmite having a BET specific surface area of at 20 to 80 m²/g, a dioctyl phthalate oil absorption (hereinafter referred to as “DOP oil absorption”) of 200 to 600 cm³/100 g, a minor axis length of 30 to 300 nm and an aspect ratio of 5 to 50.

The acicular boehmite of the present invention is useful as a filler of resins, and the resins containing the acicular boehmite of the present invention have excellent stiffness.

### DETAILED DESCRIPTION OF THE INVENTION

The BET specific surface area of the acicular boehmite of the present invention is from 20 to 80 m²/g, preferably from 30 to 70 m²/g, more preferably at least 40 m²/g. When the BET specific surface area is less than 20 m²/g, mechanical properties of resins are not sufficiently improved, even if acicular boehmite is compounded in the resins. When the BET specific surface area exceeds 80 m²/g, the acicular boehmite may not be well dispersed in the resins due to the aggregation of boehmite particles.

The minor axis length (a) of the acicular boehmite of the present invention is from 30 to 300 nm, preferably from 50 to 200 nm. When the minor axis length is less than 30 nm, the acicular boehmite may not be well dispersed in the resins due to the aggregation of boehmite particles, and furthermore, the improvement of mechanical properties of the resins may not be expected. When the minor axis length exceeds 300 nm, the major axis becomes relatively long so that the boehmite may not be well dispersed in the resins.

The major axis length (b) of the acicular boehmite of the present invention is usually from 1,000 to 10,000 nm, preferably from 2,000 to 8,000 nm.

An aspect ratio means a ratio of a minor axis (a) to a major axis (b) of acicular particles (a ratio: b/a). With acicular boehmite of the present invention, an average aspect ratio is from 5 to 50. When the aspect ratio of the acicular boehmite of the present invention is less than 5, the stiffness of resins containing boehmite may not be sufficiently improved. Acicular boehmite having an aspect ratio exceeding 50 may be rather difficult to produce. Thus, the aspect ratio is preferably 40 or less, more preferably 30 or less.

The acicular boehmite of the present invention usually has a DOP oil absorption of 200 to 600 cm³/100 g, preferably 200 to 500 cm³/100 g. When the DOP oil absorption is less than 200 cm³/100 g and the minor axis length (a) is 30 to 300 nm, the resin containing acicular boehmite exhibiting high stiffness can hardly be obtained. When the DOP oil absorption exceeds 600 cm³/100 g, a melt viscosity of a resin composition containing acicular boehmite having such a high DOP oil absorption becomes too high so that the processing and handling of the resin composition tend to become difficult. Herein, a DOP oil absorption of the acicular boehmite is measured according to JIS K6221.

In one embodiment, the acicular boehmite of the present invention preferably contains 1% by weight or less, more preferably 0.1% by weight or less of magnesium in terms of magnesium oxide, from the viewpoint of the improvement of the stiffness of the resins to which the acicular boehmite is added.

The acicular boehmite of the present invention can be produced by hydrothermally reacting aluminum hydroxide powder as a raw material at a temperature of 160 to 250° C. in an aqueous solution having pH of 4 to 6 and containing 0.1 to 5 mol/L of a salt of at least one metal ion selected from the group consisting of magnesium ion (Mg²⁺), manganese ion (Mn²⁺) and zinc ion (Zn²⁺) and at least one anion selected from the group consisting of carboxylate ion, nitrate ion (NO³⁻) and sulfate ion (SO₄²⁻).

Examples of the raw material aluminum hydroxide include aluminum hydroxide powder the primary crystal phase of which is gibbsite, bayerite, nordstrandite, tohdite, etc. Among them, aluminum hydroxide powder the main crystal phase of which is gibbsite or bayerite is preferable.

The raw material aluminum hydroxide powder usually has an average particle size of 0.1 to 10 μm, preferably 5 μm or less, more preferably 3 μm or less. The aluminum hydroxide powder having an average particle size of less than 0.1 μm is less advantageous from the viewpoint of the productivity of the acicular boehmite. When the average particle size of the aluminum hydroxide powder exceeds 10 μm, the produced acicular boehmite particles are easy to aggregate.

Examples of the carboxylate ion include formate ion, acetate ion, propionate ion, oxalate ion, glutarate ion, succinate ion, malonate ion, maleate ion, adipate ion, citrate ion, etc.

Examples of the salts of the metal ion and the anion include magnesium carboxylates such as magnesium formate, magnesium acetate, magnesium propionate, magnesium oxalate, magnesium glutarate, magnesium succinate, magnesium malonate, magnesium maleate, magnesium adipate, magnesium citrate, etc.; manganese carboxylates such as manganese formate, manganese acetate, manganese propionate, manganese oxalate, manganese glutarate, manganese succinate, manganese malonate, manganese maleate, manganese adipate, manganese citrate, etc.; zinc carboxylates such as zinc formate, zinc acetate, zinc propionate, zinc oxalate, zinc glutarate, zinc succinate, zinc malonate, zinc maleate, zinc adipate, zinc citrate, etc.; and magnesium nitrate, manganese nitrate, zinc nitrate, magnesium sulfate, manganese sulfate, zinc sulfate, etc.

The above salts may be used singly or as a mixture of two or more of them and dissolved in an aqueous solution. The concentration of the salt is usually from 0.1 to 5 mol/L, preferable 0.1 to 3 mol/L, based on the volume of the aqueous solution.

The aqueous solution has a pH of 4 to 6. When pH is less than 4, obtained boehmite particles are not acicular. When pH exceeds 6, obtained boehmite particles tend to aggregate so that the stiffness of the resin may not be sufficiently improved by the addition of the acicular boehmite to the resins.

To adjust pH (a hydrogen-ion concentration) of the aqueous solution in the above range, usually an acid is added to the aqueous solution. Examples of the acid include carboxylic acids, nitric acid, sulfuric acid, etc. Specific examples of the carboxylic acids include aliphatic carboxylic acids such as formic acid, acetic acid, propionic acid, oxalic acid, glutaric acid, succinic acid, malonic acid, maleic acid, adipic acid, citric acid, etc. Preferably, carboxylic acids are used.

The amount of the aqueous solution is usually from 5 to 50 parts by weight per one part by weight of the raw material aluminum hydroxide.

The hydrothermal reaction is carried out by dispersing the raw material aluminum hydroxide in the aqueous solution and heating the aqueous solution containing the raw material aluminum hydroxide in a reactor, for example, an autoclave under pressure.

The reaction temperature is usually from 160 to 250° C. When the reaction temperature is lower than 160° C., the reaction requires a longer reaction time or the obtained boehmite may not be acicular. When the reaction temperature is higher than 250° C., effects commensurate with such a high temperature may not be attained, and thus such a high temperature is not favorable from the viewpoint of production costs. The reaction time is usually from 2 to 24 hours. The reaction pressure is usually autogenously generated as a result of water vaporization at the reaction temperature, for example, 1.3 to 1.5 MPa when the temperature is 200° C.

The hydrothermal reaction produces the desired acicular boehmite of the present invention. The obtained acicular boehmite can be recovered from the reaction mixture by a conventional method such as filtration under atmospheric pressure, after the reaction mixture is cooled. The recovered acicular boehmite may be washed and purified with water or an alcohol such as methanol.

The acicular boehmite of the present invention is useful as a filler of resins, and resin compositions containing the acicular boehmite of the present invention have good impact resistance and also excellent stiffness.

The resins to which the acicular boehmite is compounded may be thermoplastic resins or thermosetting resins. Examples of the thermoplastic resins include polyolefin resins, polylactic acid, aromatic polyester resins, aliphatic polyester resins, aromatic polyamide resins, methacrylic resins, etc. Examples of the thermosetting resins include epoxy resins, vinyl ester resins, phenol resins, unsaturated polyester resins, polyimide resins, polyurethane resins, melamine resins, etc.

Specific examples of the polyolefin resins used according to the present invention include polypropylene resins, polyethylene resins, poly-α-olefin resins a major monomer of which comprises an α-olefin having at least 4 carbon atoms, etc. Among these polyolefin resins, polypropylene resins and polyethylene resins are preferable, and polypropylene resins are more preferable. The polyolefin resins may be used singly or as a mixture of at least two of them.

Typical examples of the polypropylene resins are propylene homopolymers, propylene-ethylene random copolymers, propylene-α-olefin random copolymers, propylene-ethylene-α-olefin random copolymers, propylene block copolymers produced by homopolymerizing propylene and then copolymerizing ethylene and propylene, etc.

The content of ethylene, the content of the α-olefin or the total content of ethylene and the α-olefin in the propylene-ethylene random copolymers, propylene-α-olefin random copolymers and propylene-ethylene-α-olefin random copolymers is less than 10% by mole, provided that the total content of propylene, ethylene and/or α-olefin is 100% by mole in each case. The content of ethylene, the content of the α-olefin or the total content of ethylene and the α-olefin in each copolymer may be measured by an IR method or a NMR method, which is described in “POLYMER ANALYSES HANDBOOK” (New Edition) (1995) edited by The Chemical Society of Japan, the Board of Polymer Analyses Research (KINOKUNIYA COMPANY LTD.).

Typical examples of the polyethylene resins are ethylene homopolymers, ethylene-propylene random copolymers, ethylene-α-olefin random copolymers, ethylene-propylene-α-olefin copolymers, etc.

The content of propylene, the content of the α-olefin or the total content of propylene and the α-olefin in the ethylene-propylene random copolymers, ethylene-α-olefin random copolymers and ethylene-propylene-α-olefin copolymers is less than 20% by mole, provided that the total content of ethylene, propylene and/or α-olefin is 100% by mole in each case.

Typical examples of the poly-α-olefin resins a major monomer of which comprises an α-olefin having at least 4 carbon atoms are α-olefin-propylene random copolymers, α-olefin-ethylene random copolymers, α-olefin-propylene-ethylene random copolymer, etc.

The content of propylene, the content of ethylene or the total content of propylene and ethylene in the α-olefin-propylene random copolymers, α-olefin-ethylene random copolymers, α-olefin-propylene-ethylene random copolymer is less than 10% by mole, provided that the total content of α-olefin, propylene and/or ethylene is 100% by mole in each case.

Examples of the α-olefin having at least 4 carbon atom used for obtaining the polyolefin resin include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 5-methyl-1-hexene, 3,4-dimethyl-1-pentene, 3-ethyl-1-pentene, 2,3,3-trimethyl-1-butene, 3-methyl-3-ethyl-1-butene, 1-octene, 4-methyl-1-pentene, 5-ethyl-1-hexene, 4,4-dimethyl-1-hexene, 6-propyl-1-butene, 6,6-methylethyl-1-heptene, 3,4,4-trimethyl-1-pentene, 4-propyl-1-pentene, 3,3-diethyl-1-butene, 1-nonene, 1-decene, 1-undecene, 1-dodecene, etc. Among them, 1-butene, 1-pentene, 1-hexene and 1-octene are preferable.

The polyolefin resins used according to the present invention may be produced by any conventional method such as solution polymerization, slurry polymerization, bulk polymerization, gas phase polymerization, etc. These polymerization methods may be employed singly or in combination of at least two methods.

Typical methods for producing polyolefin resins are described in “New Polymer Production Processes” (1994) edited by Koji SAEKI (Kogyo Chosakai Publishing, Inc.), JP-A-04-323207 and EP 0 202 946 A2 (corresponding to JP-A-61-287917).

When the polyolefin resins used according to the present invention are polypropylene resins, they are preferably produced by the methods described above.

A catalyst used in the production of the polyolefin resins may be a multisite catalyst or a single site catalyst. Preferable examples of the multisite catalyst include catalysts comprising a solid catalyst component containing a titanium atom, a magnesium atom and a halogen atom. Preferable examples of the single site catalyst include metallocene complexes.

When the polyolefin resins used according to the present invention are polypropylene resins, preferable catalysts to be used in the production of the polypropylene resins are the catalysts exemplified above.

Preferred examples of the polyamide resins include Nylon 6, Nylon 46, Nylon 66, Nylon 10, Nylon 11, Nylon 12, Nylon 6,10, Nylon 6,12, etc., although any conventional polyamide resins other than these Nylons may be used. Blends of these polyamide resins may be used. Furthermore, aromatic polyamides, for example, copolyamides such as polyhexamethylene isophthalamide (Nylon 6I) may be used. Such thermoplastic copolyamides comprising an aromatic component mean melt-polymerizable polyamides comprising aromatic amino acid and/or aromatic dicarboxylic acids such as p-(aminomethyl)benzoic acid, p-(aminoethyl)benzoic acid, terephthalic acid, isophthalic acid, etc. as main constituent components. Examples of diamines, which are other constituent components, include hexamethylenediamine, undecamethylenediamine, dodecamethylenediamine, 2,2,4- or 2,4,4-trimethylhexamethylenediamine, m- or p-xylylenediamine, bis(p-aminocyclohexyl)methane, bis(p-aminocyclohexyl)propane, bis(3-methyl-4-aminocyclohexyl)methane, 1,3-bis(aminomethyl)cyclohexane, 1,4-bis(aminomethyl)cyclohexane, etc.

Examples of polylactic acid include lactic acid homopolymers, copolymers of lactic acid and other hydroxycarboxylic acid, etc. Examples of the other hydroxycarboxylic acid used as a comonomer include glycolic acid, hydroxybutyric acid, hydroxyvaleric acid, hydroxypentanoic acid, hydrocycaproic acid, hydroxyheptanoic acid, etc.

The polylactic acid may have a molecular structure comprising repeating units of either L-lactic acid or D-lactic acid, and optionally repeating units of an enantiomer of each lactic acid.

The content of the repeating units of each of L-lactic acid and D-lactic acid in the polylactic acid is usually from 85 to 100% by mole, preferably from 85 to 98% by mole. The content of the repeating units of each enantiomer is usually from 0 to 15% by mole, preferably from 2 to 15% by mole. In each case, the whole polylactic acid is 100% by mole.

The content of the repeating units of each of L-lactic acid and D-lactic acid in the copolymer of lactic acid with other hydroxycarboxylic acid is usually from 85 to 100% by mole, preferably from 85 to 98% by mole, while that of the other hydroxycarboxylic acid is 0 to 15% by mole, preferably from 2 to 15% by mole.

The polylactic acid used according to the present invention may be produced by any conventional method, for example, by polycondensation of at least one compound selected from the group consisting of L-lactic acid, D-lactic acid and other hydroxycarboxylic acids with dehydration, preferably ring-opening polymerization of at least one compound selected from the group consisting of a lactide as a cyclic dimer of lactic acid, a glycolide as a cyclic dimer of glycolic acid, and caprolactone.

Examples of the lactide include L-lactide (a cyclic dimer of L-lactic acid), D-lactide (a cyclic dimer of D-lactic acid), mesolactide (a cyclic dimer of L-lactide and D-lactide), and DL-lactide, namely, a racemic mixture of L-lactide and D-lactide. Any lactide may be used according to the present invention. Among them, D-lactide or L-lactide is preferably used as a main raw material.

To accelerate the production of the polylactic acid, a polymerization catalyst may be used in the polymerization of a lactide or the copolymerization of a lactide and a glycolide.

Examples of the polymerization catalyst include compounds comprising polyvalent metals such as stannous octanoate, tin tetrachloride, zinc chloride, titanium tetrachloride, iron chloride, boron trifluoride ether complex, aluminum chloride, antimony trifluoride, zinc oxide, etc. Among them, the tin compounds and the zinc compounds are preferable. Among the tin compounds, stannous octanoate is more preferable.

The amount of the polymerization catalyst is usually from 0.001 to 0.1% by weight based on the whole weight of the lactide, or the total weight of the lactide and the glycolide.

During the production of the polylactic acid, a chain extender may be used. Preferable examples of the chain extender are higher alcohols such as lauryl alcohol, etc., and hydroxy acids such as glycolic acid, etc.

The presence of a chain extender accelerates the polymerization reaction so that the polylactic acid can be produced in a shorter reaction time. Furthermore, the molecular weight of the polylactic acid can be controlled by the adjustment of the amount of the chain extender.

The production of the polylactic acid may be carried out by solution polymerization in the presence of a solvent, bulk polymerization in which the lactide or the glycolide is polymerized in a melt state in the absence of a solvent. The bulk polymerization is preferable.

The polymerization temperature in the bulk polymerization may be higher than the melting point of the lactide or the glycolide (around 90° C.). In the case of the solution polymerization, the polymerization reaction can be carried out at a temperature lower than the melting point of the lactide or the glycolide. In each case of the solution and bulk polymerization, the polymerization temperature is not higher than 250° C., since the polylactic acid to be produced may decompose at a temperature higher than 250° C.

To compound the acicular boehmite of the present invention in the resin, for example, when a thermoplastic resin is used as the resin, the thermoplastic resin is melt kneaded together with the acicular boehmite of the present invention. For melt kneading, a kneader or a mixer such as a Banbury mixer, a plastomil, a Blabender plastograph, a single screw extruder, a twin screw extruder, etc.

When a thermosetting resin is used as the resin, an uncured thermosetting resin is mixed with the acicular boehmite of the present invention and then heated to cure the resin. For mixing, a Henschel mixer, a ribbon blender, etc. may be used.

The amount of the acicular boehmite compounded in the resin is usually at least 0.1 part by weight, preferably at least 1 part by weight, per 100 parts by weight of the resin. The upper limit of the amount of the acicular boehmite added to the resin is usually 100 parts by weight, preferably 50 parts by weight from the viewpoint of the easiness of the compounding of the acicular boehmite in the resin and the moldability of the resin composition containing the acicular boehmite.

The resin composition comprising the acicular boehmite may optionally contain conventional additives such as dispersants, lubricants, plasticizers, flame retardants, antioxidants, antistatic agents, light stabilizers, UV absorbers, nucleating agents (crystallization accelerators), colorants such as pigments and dyes, etc. Besides the acicular boehmite of the present invention, the resin composition may contain other fillers, for example, particulate fillers such as carbon black, titanium oxide, talc, calcium carbonate, mica, clay, etc., short fibrous fillers such as wollastonite, etc., whiskers such as potassium titanate whiskers, etc., and the like.

The resin composition is usually shaped in the form of a molded article. Examples of molding methods include injection molding, compression molding, extrusion molding, etc.

Hereinafter, the present invention will be illustrated by the following Examples, which do not limit the scope of the present invention in any way.

In the Examples, the properties were measured or evaluated by the following methods:

(1) A BET specific surface area (m²/g) was measured by a nitrogen adsorption method.

(2) A minor axis length (a) and a major axis length (b) of acicular boehmite were measured by taking a photograph of acicular boehmite particles by a scanning or transmission electron microscope, arbitrarily selecting 10 particles of the acicular boehmite from the electron microphotograph, and measuring the minor and major axis lengths of the ten particles followed by averaging to obtain a number average minor or major axis length.

(3) An aspect ratio is a number average aspect ratio obtained by averaging the aspect ratios of the ten particles selected in (2) above, which are obtained by dividing the major axis length by the miner axis length of each particle.

(4) A DOP oil absorption (cm³/100 g) was measured according to JIS K6221.

(5) An aggregated particle size (μm) was measured with a laser scattering type particle size distribution analyzer (Microtrac HRA manufactured by LEED & NORTHRUP Co., Ltd.) by dispersing 0.01 g of the obtained acicular boehmite in 300 g of purified water to obtain D50 (by weight).

(6) A flexural modulus (MPa) was measured according to JIS K7171 at a span length of 64 mm, a rate of load application of 2 mm/min. at 23° C.

(7) A notched Izod impact strength (kJ/m²) was measured according to JIS K7110 at 23° C.

### EXAMPLE 1

100 Parts by weight of gibbsite type aluminum hydroxide having a BET specific surface area of 25 m²/g and a center particle size of 0.5 μm, 219 parts by weight of magnesium acetate tetrahydrate (CH₃COOMg.4H₂O) and 2,100 parts by weight of purified water were mixed to obtain a slurry. To the slurry, a suitable amount of acetic acid was added to adjust pH of the slurry to 5.0. Then, the slurry was put in an autoclave and heated from room temperature (about 20° C.) to 200° C. at a heating rate of 100° C./hr. and maintained at 200° C. for 4 hours to effect the hydrothermal reaction. Thereafter, the mixture was cooled and the solid material was recovered by filtration and washed with water until the electric conductivity of the filtrate became 100 μS/cm or less, followed by the addition of purified water to obtain a slurry having a solid content of 5% by weight. From this slurry, coarse particles were removed with a SUS filter having openings of 45 μm, and the slurry was spray dried with a spray drier (MOBILE MINOR® manufactured by Niro Japan Co., Ltd.) at an exit temperature of 120° C. The spray dried granules were broken with a rotor speed mill (P-14 manufactured by Fritsch GmbH) to obtain acicular boehmite particles, which had a BET specific surface area of 66 m²/g, a DOP oil absorption of 300 cm³/100 g, a minor axis length of 102 nm, a major axis length of 2520 nm, an aspect ratio of 27, and a center particle size of 1.4 μm.

10 Parts by weight of the acicular boehmite produced in the previous step, 100 parts by weight of an ethylene-propylene block copolymer (ethylene content: 19% by weight; MFR: 30 g/10 min.) and 0.2 part by weight of an antioxidant (Irganox® 1010 manufactured by Ciba Specialty Chemicals) were melt kneaded with a labo plastomil (100 M manufactured by Toyo Seiki Seisaku-Sho, Ltd.; Kneading section: B 600 type) at 180° C., 60 rpm for 10 minutes, and the mixture was extruded with a complex kneader (manufactured by IMOTO MACHINERY CO., LTD.) to form strands each having a diameter of 3 mm, which were cut to obtain pellets.

The obtained pellets were injection molded with a semi-automatic injection molding machine (manufactured by IMOTO MACHINERY CO., LTD.) at a resin temperature of 230° C. to obtain a test piece having a width of 12 mm, a length of 80 mm and a thickness of 4 mm. The flexural modulus of this test piece was 1,998 MPa.

Separately, the pellets were injection molded by the same method as above to obtain a test piece having a width of 12 mm, a length of 64 mm and a thickness of 4 mm. The notched Izod impact strength of this test piece was 6.0 kJ/m². The properties of the resin composition are shown in TABLE 1.

### COMPARATIVE EXAMPLE 1

100 Parts by weight of the same gibbsite type aluminum hydroxide as one used in EXAMPLE 1, 218 parts by weight of magnesium acetate tetrahydrate and 2,100 parts by weight of purified water were mixed to obtain a slurry. To this slurry, another slurry (solid content: 10% by weight), which was produced by dispersing boehmite type aluminum hydroxide having a BET specific surface area of 307 m²/g (produced by hydrolyzing aluminum alkoxide) in 0.1 N aqueous nitric acid (nitric acid concentration: 0.1 mol/L), was added. As a result, pH of the resulting slurry was 7.0. Then, the mixed slurry was put in an autoclave and heated from room temperature (about 20° C.) to 200° C. at a heating rate of 100° C./hr. and maintained at 200° C. for 4 hours to effect the hydrothermal reaction. Thereafter, the same procedures as in EXAMPLE 1 were repeated to obtain acicular boehmite, and also test pieces were produced. The properties of the resin composition are shown in TABLE 1.

TABLE 1

Example No.

| | 1 | Comp. 1 |
|---|---|---|
| Gibbsite (pbw) | 100 | 100 |
| Boehmite (pbw) | 0 | 5 |
| Magnesium acetate (pbw) | 219 | 218 |
| Purified water (pbw) | 2100 | 2100 |
| Salt concenration (mol/L) | 0.47 | 0.47 |
| pH | 5.0 | 7.0 |
| BET specific surface area (m²/g) | 66 | 126 |
| DOP oil absorption (cm³/100 g) | 300 | 305 |
| Minor axis length (nm) | 102 | 7 |
| Aspect ratio | 27 | 16 |
| Major axis length (nm) | 2520 | 103 |
| Center particle size (μm) | 1.4 | 3.0 |
| Flexural modulus (MPa) | 1998 | 1542 |
| Izod impact strength (kJ/m²) | 6.0 | 6.2 |

### EXAMPLE 2

Acicular boehmite was produced by the same hydrothermal reaction as in EXAMPLE 1 except that 100 parts by weight of commercially sold gibbsite type aluminum hydroxide (C-301 manufactured by Sumitomo Chemical Co., Ltd.; center particle size: 1.4 μm) in place of the gibbsite aluminum hydroxide of EXAMPLE 1, the amount of magnesium acetate tetrahydrate was changed to 335 parts by weight, and the amount of purified water was changed to 3,200 parts by weight. Then, test pieces were produced in the same manner as in EXAMPLE 1 except that the acicular boehmite produced in the previous step was used. The properties of the resin composition are shown in TABLE 2.

### EXAMPLE 3

Acicular boehmite was produced by the same hydrothermal reaction as in EXAMPLE 2 except that the amount of magnesium acetate tetrahydrate was changed to 168 parts by weight. Then, test pieces were produced in the same manner as in EXAMPLE 1 except that the acicular boehmite produced in the previous step was used. The properties of the resin composition are shown in TABLE 2.

### COMPARATIVE EXAMPLE 2

The slurries were produced in the same manner as in EXAMPLE 2 except that the amount of magnesium acetate tetrahydrate was changed to 46 parts by weight and no acetic acid was added. The slurry after mixing had pH of 7.7. Then, the hydrothermal reaction was carried out under the same conditions and test pieces were produced in the same manner as in EXAMPLE 1. The properties of the resin composition are shown in TABLE 2.

TABLE 2

| | Example No. | | |
|---|---|---|---|
| | 2 | 3 | Com. 2 |
| Gibbsite (pbw) | 100 | 100 | 100 |
| Magnesium acetate (pbw) | 335 | 168 | 46 |
| Purified water (pbw) | 3200 | 3200 | 3200 |
| Salt concentration (mol/L) | 0.47 | 0.24 | 0.067 |
| pH | 5.0 | 5.0 | 7.7 |
| BET specific surface area (m²/g) | 67 | 58 | 14 |
| DOP oil absorption (cm³/100 g) | 340 | 288 | 197 |
| Minor axis length (nm) | 92 | 222 | 436 |
| Aspect ratio | 24 | 13 | 11 |
| Major axis length (nm) | 2170 | 2810 | 4820 |
| Center particle size (μm) | 7.0 | 6.0 | 5.0 |
| Flexural modulus (MPa) | 2026 | 1965 | 1583 |
| Izod impact strength (kJ/m²) | 7.1 | 6.5 | 6.2 |

### EXAMPLE 4

100 Parts by weight of polylactic acid (LACTRON™ 100) and 11 parts by weight of the acicular boehmite produced in EXAMPLE 2 were melt kneaded in a twin screw extruder (KZW 15-45 MG manufactured by TECHNOVEL Corporation; Screw diameter: 15 mm) at 220° C. to obtain a resin composition. This resin composition was injection molded with an injection molding machine (PLASTAR TU-151 manufactured by TOYO MACHINERY & METAL CO., LTD.) to obtain a test piece having a width of 10 mm, a length of 80 mm and a thickness of 4 mm. This test piece had a flexural modulus of 5,022 MPa and a notched Izod impact strength of 2 kJ/m².

### COMPARATIVE EXAMPLE 3

The same polylactic acid as used in EXAMPLE 4 alone was injection molded to obtain a test piece. This test piece had a flexural modulus of 2,900 MPa and a notched Izod impact strength of 2 kJ/m².

### EXAMPLE 5

100 Parts by weight of Nylon 6 (A 1030 BRL manufactured by UNITIKA Ltd.) and 11 parts by weight of the acicular boehmite produced in EXAMPLE 1 were melt kneaded in a labo plastomil (100 M manufactured by Toyo Seiki Seisaku-Sho, Ltd.; Kneading section: B 600 type) at 250° C., 60 rpm for 10 minutes, and pulverized into a size of 4 mm or less with a power cutting mill (SM 2000 manufactured by Retsch Co., Ltd.) to obtain composite powder. The obtained powder was injection molded with a semi-automatic injection molding machine (manufactured by IMOTO MACHINERY CO., LTD.) at a resin temperature of 250° C. to obtain a test piece having a width of 12 mm, a length of 80 mm and a thickness of 4 mm. The flexural modulus of this test piece was 3,473 MPa.

Separately, the powder was injection molded by the same method as above to obtain a test piece having a width of 12 mm, a length of 64 mm and a thickness of 4 mm. The notched Izod impact strength of this test piece was 6.5 kJ/m².

### COMPARATIVE EXAMPLE 4

The same Nylon 6 as used in EXAMPLE 5 alone was injection molded to obtain a test piece. This test piece had a flexural modulus of 1,804 MPa and a notched Izod impact strength of 6.3 kJ/m².

### EXAMPLE 6

100 Parts by weight of commercially sold gibbsite type aluminum hydroxide (C-301 manufactured by Sumitomo Chemical Co., Ltd.; center particle size: 1.4 μm), 218 parts by weight of magnesium acetate tetrahydrate and 1,236 parts by weight of purified water were mixed to obtain a slurry. To the slurry, 29 parts by weight of acetic acid was added to adjust pH of the slurry to 5.0. Then, the slurry was put in an autoclave and heated from room temperature (about 20° C.) to 200° C. at a heating rate of 100° C./hr. and maintained at 200° C. for 4 hours to effect the hydrothermal reaction. The pH of the slurry after hydrothermal reaction was 5.0. Thereafter, the mixture was cooled and the solid material was recovered by filtration and washed with water until the electric conductivity of the filtrate became 100 μS/cm or less, followed by dryihg in an oven at 120° C. The dried solid granules were broken with a rotor speed mill to obtain acicular boehmite particles, which had a BET specific surface area of 64 m²/g, a DOP oil absorption of 240 cm³/100 g, a minor axis length of 114 nm, a major axis length of 1,960 nm, an aspect ratio of 20, and a center particle size of 6.6 μm.

To 6 parts by weight of the acicular boehmite produced in the previous step and 94 parts by weight of an ethylene-propylene block copolymer (ethylene content: 19% by weight; MFR: 30 g/10 min.), 0.05 part by weight calcium stearate (manufactured by NOF Corporation), 0.1 part by weight of an antioxidant (Irganox® 1010 manufactured by Ciba Specialty Chemicals) and 0.1 part by weight of a heat stabilizer (Irgafos® 168 manufactured by Ciba Specialty Chemicals) were added and uniformly mixed, and then the mixture was melt kneaded with a twin screw extruder (2D30W2 manufactured by Toyo Seiki Seisaku-Sho, Ltd.) at 180° C. and a screw revolution of 50 rpm to obtain pellets.

The obtained pellets were injection molded with a semi-automatic injection molding machine (manufactured by IMOTO MACHINERY CO., LTD.) at a resin temperature of 230° C. to obtain a test piece having a width of 12 mm, a length of 80 mm and a thickness of 4 mm. The flexural modulus of this test piece was 1,858 MPa.

Separately, the pellets were injection molded by the same method as above to obtain a test piece having a width of 12 mm, a length of 64 mm and a thickness of 4 mm. The notched Izod impact strength of this test piece was 6.5 kJ/m². The properties of the resin composition are shown in TABLE 3.

### COMPARATIVE EXAMPLE 5

Acicular boehmite was produced in the same manner as in EXAMPLE 6 except that no acetic acid was added. Before and after the hydrothermal reaction, pH of the slurry was 7.8 and 5.4, respectively. The acicular boehmite obtained had a BET specific surface area of 43 m²/g, a DOP oil absorption of 172 cm³/100 g, a minor axis length of 73 nm, a major axis length of 1,980 nm, an aspect ratio of 29, and a center particle size of 7.8 μm.

Then, a test piece was produced in the same manner as in EXAMPLE 6. It had a flexural modulus of 1,490 MPa and a notched Izod impact strength of 7.6 kJ/m². The properties of the resin composition are shown in TABLE 3.

### COMPARATIVE EXAMPLE 6

Acicular boehmite was produced in the same manner as in EXAMPLE 6 except that the amount of water was changed to 1,382 parts by weight, the amount of magnesium acetate tetrahydrate was changed to 100 parts by weight and no acetic acid was added. Before and after the hydrothermal reaction, pH of the slurry was 7.9 and 5.6, respectively. The acicular boehmite obtained had a BET specific surface area of 33 m²/g, a DOP oil absorption of 181 cm³/100 g, a minor axis length of 104 nm, a major axis length of 2,650 nm, an aspect ratio of 26, and a center particle size of 6.2 μm.

Then, a test piece was produced in the same manner as in EXAMPLE 6. It had a flexural modulus of 1,531 MPa and a notched Izod impact strength of 7.5 kJ/m². The properties of the resin composition are shown in TABLE 3.

TABLE 3

| | Example No. | | |
|---|---|---|---|
| | 2 | 3 | Com. 2 |
| Gibbsite (pbw) | 100 | 100 | 100 |
| Magnesium acetate (pbw) | 218 | 218 | 100 |
| Purified water (pbw) | 1236 | 1382 | 1382 |
| Salt concentration (mol/L) | 0.78 | 0.70 | 0.33 |
| pH | 5.0 | 7.8 | 7.9 |
| BET specific surface | 64 | 43 | 33 |
| area (m²/g) | | | |
| DOP oil absorption | 240 | 172 | 181 |
| (cm³/100 g) | | | |
| Minor axis length (nm) | 114 | 73 | 104 |
| Aspect ratio | 20 | 29 | 26 |
| Major axis length (nm) | 1960 | 1980 | 2650 |
| Center particle size (μm) | 6.6 | 7.8 | 6.2 |
| Flexural modulus (MPa) | 1858 | 1490 | 1531 |
| Izod impact strength (kJ/m²) | 6.5 | 7.6 | 7.5 |

What is claimed is:

1. Acicular boehmite having a BET specific surface area of at 20 to 80 m²/g, a dioctyl phthalate oil absorption of 200 to 600 cm³/100 g, a minor axis length of 30 to 300 nm and an aspect ratio of 5 to 50.

2. A process for producing acicular boehmite comprising the step of hydrothermally reacting aluminum hydroxide powder at a temperature of 160 to 250° C. in an aqueous solution having pH of 4 to 6 and containing 0.1 to 5 mol/L of at least one salt comprising at least one metal ion selected from the group consisting of magnesium ion, manganese ion and zinc ion and at least one anion selected from the group consisting of carboxylate ion, nitrate ion and sulfate ion.

3. A resin composition comprising a resin and acicular boehmite according to claim 1.

4. The resin composition according to claim 3, wherein said resin is at least one resin selected from the group consisting of polyolefin resins, polylactic acid resins and polyamide resins.
